(19) United States
(12) Patent Application Publication
(10) Pub. No.: US 2012/0284147 A1
(43) Pub. Date: Nov. 8, 2012

(54) Online Payment Method and Device

(75) Inventors: Qionglin Nie, Hangzhou (CN); Liang Yang, Hangzhou (CN); Renchen Huang, Hangzhou (CN); Yao Zhang, Hangzhou (CN); Peng Wei, Hangzhou (CN); Xiaolong Ma, Hangzhou (CN); Qun Wang, Hangzhou (CN)

(73) Assignee: ALIBABA GROUP HOLDING LIMITED, Grand Cayman (KY)

(21) Appl. No.: 13/517,912

(22) PCT Filed: Apr. 19, 2012
(86) PCT No.: PCT/US12/34251

§ 371 Date: Jun. 20, 2012

(30) Foreign Application Priority Data
Apr. 27, 2011 (CN) 201110106712.8

(51) Int. Cl. G06Q 30/06

(52) U.S. Cl. 705/26.41

(57) ABSTRACT

In a commerce transaction between a buyer and seller that involves transfer of an item, payment is made through an independent online payment system. A seller sends a threshold amount and a payment amount to a payment server for the transaction involving the item. The payment server creates an intermediate account based on the threshold amount and the payment amount. To proceed with the transaction, a buyer transfers a fund amount to the payment server. The payment server determines whether the fund amount is not less than the threshold amount, and if so, the payment server designates the fund amount as an account balance associated with the buyer in the intermediate account. The payment server then transfers funds corresponding to the payment amount from the intermediate account to an account designated by the seller after receiving a payment request indicating the buyer's receipt of the item.

### CROSS REFERENCE TO RELATED PATENT APPLICATIONS

This application is a national stage application of an international patent application PCT/US12/34251, filed Apr. 19, 2012, which claims priority to Chinese Patent Application No. 201110106712.8, filed on Apr. 27, 2011, entitled “A Method and Device for Online Payment,” which applications are hereby incorporated by reference in their entirety.

### TECHNICAL FIELD

This disclosure relates to the field of computer technology. Specifically, this disclosure relates to a method and device for online payment.

### BACKGROUND

Following the continuous development of network technology, online transactions have become an important way of conducting commerce transactions. Online transactions may include an online payment system, which may refer to the payment segment in the computer network system. Through this payment system, a buyer initiates or completes an online transaction process. The online payment system can be used as a stand-alone system, which receives payment instructions from the online transaction system to complete the payment operation. The online payment system can also be used as a component of the online transaction system, which completes the payment operation of the online transaction. However, conventional online payment systems may present some problems (e.g., inefficiency and security risks). For example, the system may not be able to monitor and control transactions when a buyer pays a seller a large amount of money in a single transaction or when a buyer pays a seller for the same goods or service in a large number of transactions.

### SUMMARY

This disclosure provides methods and devices for online payments. A server may receive, from a device of a first user, payment terms specifying a payment threshold and a payment amount that are associated with a commerce transaction involving an item. The server may then generate an intermediate account based on the threshold amount and the payment amount. The server may also receive funds from an account designated by a second user. The server determines whether the funds are less than the threshold amount, and if not, the server designates the funds as an account balance of the second user in the intermediate account. The server may then transfer a corresponding amount from the intermediate account to an account designated by the first user after receiving a payment request indicating receipt of the item by the second user.

### BRIEF DESCRIPTION OF THE DRAWINGS

The Detailed Description is described with reference to the accompanying figures. The use of the same reference numbers in different figures indicates similar or identical items.

FIG. 1 is a block diagram of an illustrative environment that supports electronic commerce transactions and online payments.

FIG. 2 is a flow diagram of a first illustrative process to conduct a transaction using an online payment.

FIG. 3 is a graph of an illustrative table to show a first example of an intermediate account table.

FIG. 4 is a graph of another illustrative table to show a second example of an intermediate account table.

FIG. 5 is a graph of yet another illustrative table to show a third example of an intermediate account table.

FIG. 6 is a graph of still another illustrative table to show a fourth example of an intermediate account table.

FIG. 7 is a flow diagram of a second illustrative process to conduct a transaction using an online payment.

FIG. 8 is a graph of an illustrative table to show a first example of a balance refund.

FIG. 9 is a graph of another illustrative table to show a second example of a balance refund.

FIG. 10 is a block diagram of an illustrative computing device of various components included in the computing environment of FIG. 1.

### DETAILED DESCRIPTION

Techniques for conducting electronic transactions using an online payment system are disclosed. According to the techniques described herein, a seller may designate a threshold amount of money for a temporary or intermediate account and an amount of payment for goods or service involved in a transaction. A transaction server creates the intermediate account based on the threshold amount and the amount of payment. A buyer indicates that he or she agrees with the threshold amount and the payment amount when the buyer allocates funds to the intermediate account. The transaction server may then designate the allocated funds as an account balance of the buyer if the allocated funds are not less than the threshold amount. The transaction server may then allocate an amount equal to the amount of payment from the account balance to the seller when the seller has provided goods or services to the buyer. The transaction server may freeze the account balance of the buyer after the transaction.

For convenience, in this disclosure, a first user typically refers to a seller and a second user typically refers to a buyer. The account balance refers to a buyer's account balance in the intermediate account.

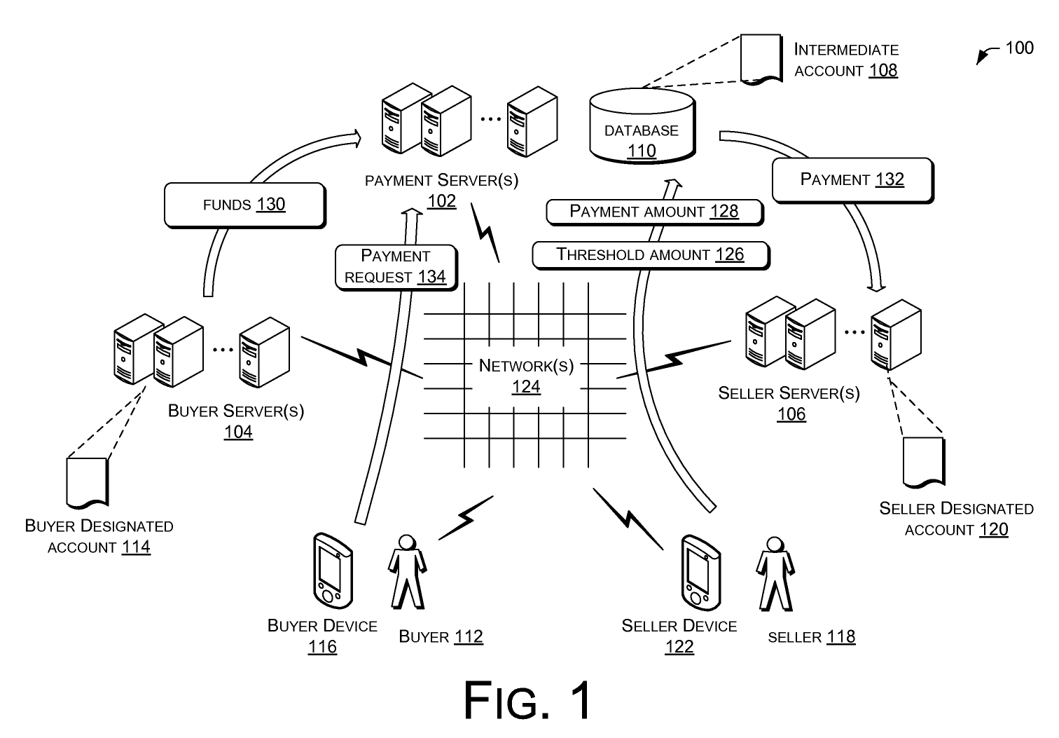

FIG. 1 is a block diagram of an illustrative environment 100 that supports electronic commerce transactions and online payments. The environment 100 includes a payment server 102, a buyer server 104, and a seller server 106. The payment server 102 is independent from the buyer server 104 and the seller server 106 to guarantee fund security for advanced payment businesses. The payment server 102 may include and manage an intermediate account 108 stored in a database 110. The intermediate account 108 may include an intermediate account table containing information associated with transactions between buyers and sellers. Neither the buyer server 104 nor the seller server 106 has access to the intermediate account 108.

A buyer 112 may allocate funds from a buyer designated account 114 on the buyer servers 104 to the intermediate account 108 via a buyer device 116. Similarly, the seller 118 may receive funds from the intermediate account 108 to a seller designated account 120 on the seller servers 106 via a seller device 122. The buyer server 104 and the seller server 106 manage designated accounts of the buyer 112 and the seller 118, respectively. The buyer device 116 and the seller device 122 may be mobile telephones, smart phones, tablet computers, laptop computers, or any other mobile computing device that include a display and can connect to a network(s) 124 to exchange information with the payment server 102 and the buyer server 104 or the seller server 106. In some embodiments, neither the buyer 112 nor the seller 118 has access to the intermediate account 108.

In some embodiments, the buyer designated account 114 may be an account handled and/or accessed by the buyer 112 via the buyer device 116. For example, the buyer designated account 114 may include the buyer's online bank account, and the buyer server 104 may be an online bank server. The seller designated account 120 may be an account handled and/or accessed by the buyer 112 via the seller device 122. For example, the seller designated account 120 may include the seller's online bank account, and the seller server 106 may be an online bank server.

In some embodiments, the seller 118 may determine payment terms that include a threshold amount 126, which may be a buyer's one-time allocation for one or more transactions. The payment terms may also include a payment amount 128 corresponding to goods and/or services. The seller device 122 may then transmit payment terms to the payment server 102. The payment server 102 may then generate the intermediate account 108 based on payment terms. For example, the payment server 102 may designate a single deduction as the payment amount 128 associated with the threshold amount 126.

In some embodiments, the buyer 112 may allocate funds 130 to the intermediate account 108 when she or he wants to purchase goods and/or services and agrees with the threshold amount 126 and the payment amount 128 for the goods and/or services. For example, the buyer 112 may transfer the funds 130 corresponding to the threshold amount 126 from the buyer designated account 114 to the intermediate account 108. After receiving the funds 130, the payment server 102 may then designate the amount money as the buyer's account balance associated with the intermediate account 108. The payment server 102 may transfer payment 132 corresponding to the payment amount 128 to the seller designated account 120 after the buyer 112 receives the goods and/or services. The payment server 102 may update the account balance of the buyer 112 in the intermediate account 108, and then freeze the account balance.

The payment server 102 may be independent from an online transaction system, or be a part of the online transaction system. For example, the online transaction system can send instructions to the payment server 102 to transfer the payment 132 to the seller designated account 120 in response to the buyer's payment request after a transaction is successfully conducted.

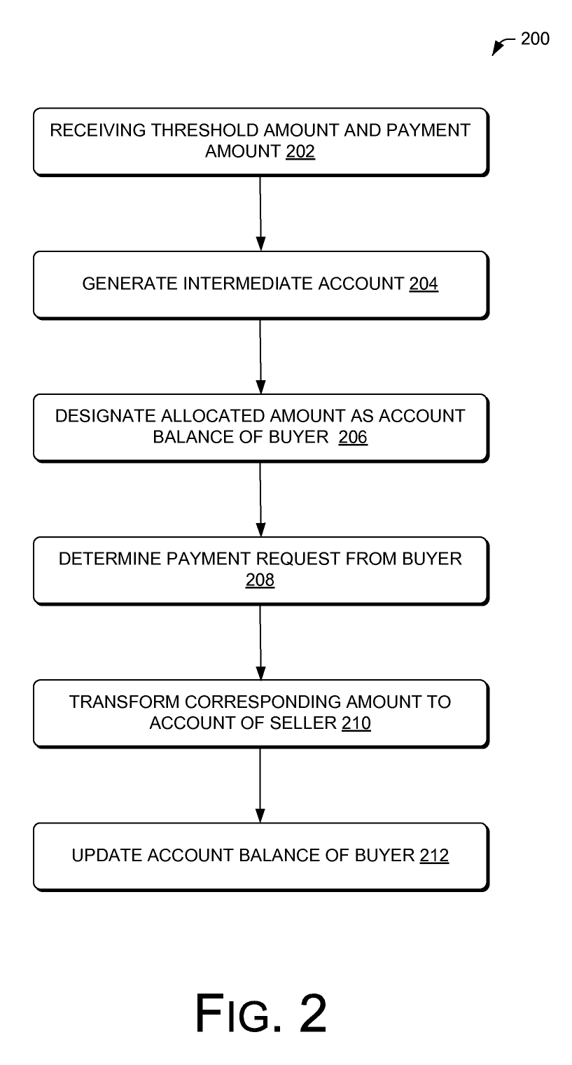

FIG. 2 is a flow diagram of an illustrative process 200 to conduct a transaction using an online payment. At 202, the payment server 102 may receive payment terms associated with the transaction. The payment terms may include the threshold amount 126, the payment amount 128, a seller ID associated with the payment server 102, and information associated with the seller designated account 120. In some embodiments, the seller 118 may log in to the payment server 102, for example, using the combination of his or her user name and password or may register for services provided by the payment server 102 for a first time. In some embodiments, the payment serve 102 may authenticate the seller's identity, and then assign a particular seller ID to the seller 118. In some embodiments, the threshold amount 126 may be greater than N times of the payment amount 128, where N may be predetermined by the seller 118 or the payment server 102.

At 204, the payment server 102 may generate a temporary or intermediate account 108 based on the payment amount 128 and the threshold amount 126. In some embodiments, the seller 118 may log in a website implemented by the payment server 102, which in turn serves a webpage. The seller 118 may populate the webpage with corresponding information. For example, the seller 118 may enter the “seller's ID as X”, “threshold value as 1000”, “payment value as 100”, “the seller's designated account information as abc”. In some embodiments, the seller 118 may use a Short Messaging System (SMS) and other wireless communication methods to send requests to generate the intermediate account 108. For example, the seller 118 may compose a SMS message that contains the payment terms, and send via the seller device 122 the SMS message to the payment server 102 using the SMS gateway.

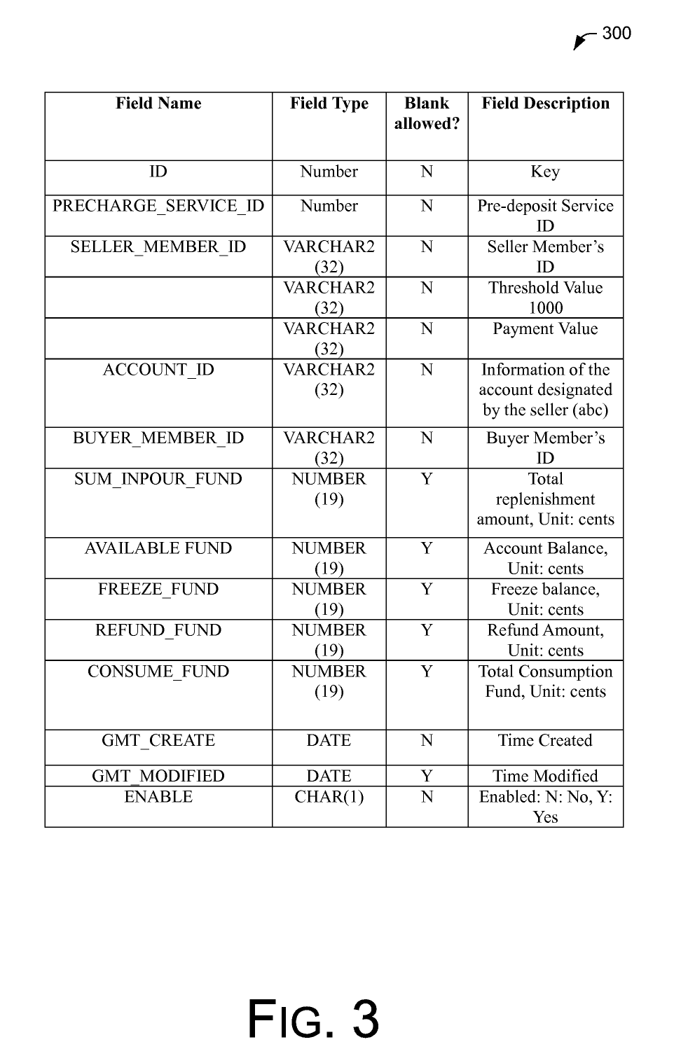

When the payment server 102 receives the seller's request to create the intermediate account 108, the payment server 102 may generate the intermediate account 108 and populate corresponding fields of the intermediate account 108 with the payment terms. For example, FIG. 3 shows an illustrative intermediate account table 300, which includes information associated with the seller 118 (e.g., seller's ID as “X” and the seller designated account 120 “abc”).

At 206, the payment server 102 may designate the funds 130 as an account balance of the buyer 112. In some embodiments, the payment server 102 may receive the funds 130 transmitted by the buyer device 116 and determine that the funds 130 are not less than the threshold amount 126. The payment server may then designate the funds 130 as the buyer's account balance.

The buyer 112 may register in Website implemented by the payment server 102 and be assigned an ID by the payment server 102. After the payment server 102 generates the intermediate account 108, the seller 118 may release product information in shopping websites. The product information may include the seller's ID, a product that the seller 118 provides, service contents, and the threshold amount 126 and the payment amount 128 corresponding to the product.

In some embodiments, the buyer 112 may communicate with the seller 118 through an online trading platform and then transfer the funds 130 to the intermediate account 108 from the buyer designated account 114 in response to a request of the seller 118. For example, the seller 118 may populate a shopping website a link to payment terms that contains the threshold amount 126 and the payment amount 128. The link may lead the buyer 112 to the seller 118 and enable their communication.

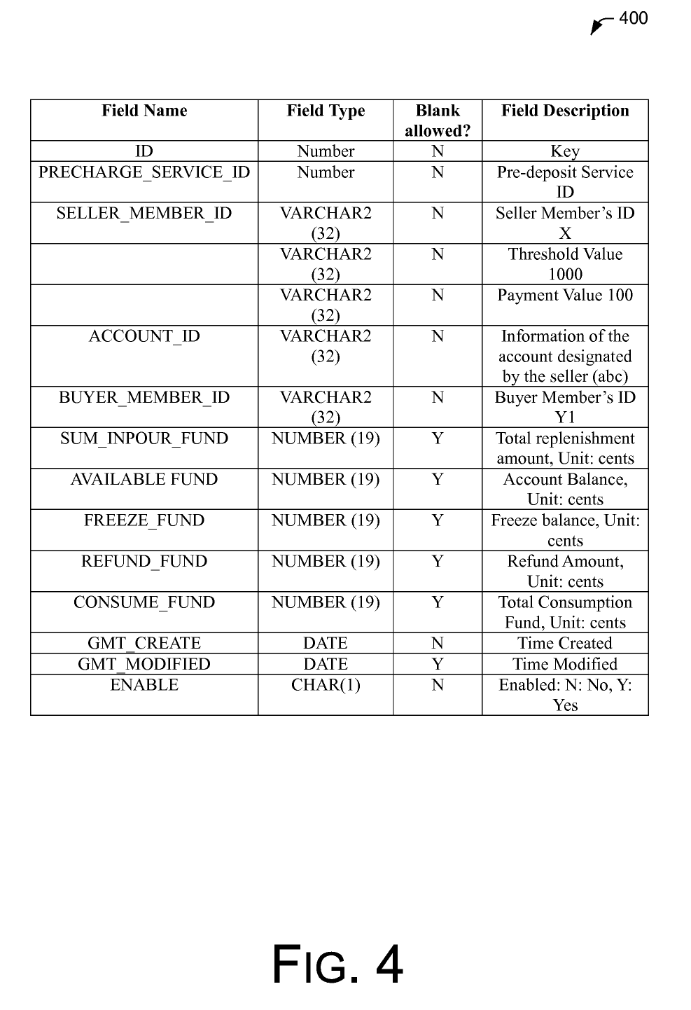

After the payment server 102 determine that the buyer 112 has replenished the intermediate account 108 (i.e., allocate funds), the payment server 102 may authenticate the identity of the buyer 112. After successful authentication, the payment server 102 may retrieve corresponding information from the intermediate account 108. For example, the payment server 102 may read the threshold amount 126 from the intermediate account 108 (e.g., the intermediate account table 300). The payment server 102 may then compare the funds 130 with the threshold amount 126. If the funds 130 are not less than the threshold amount 126, the payment server 102 may designate the funds 130 as the buyer's account balance in the intermediate account. The payment server 102 may also update the intermediate account table 300 to generate an intermediate account table 400 as shown in FIG. 4.

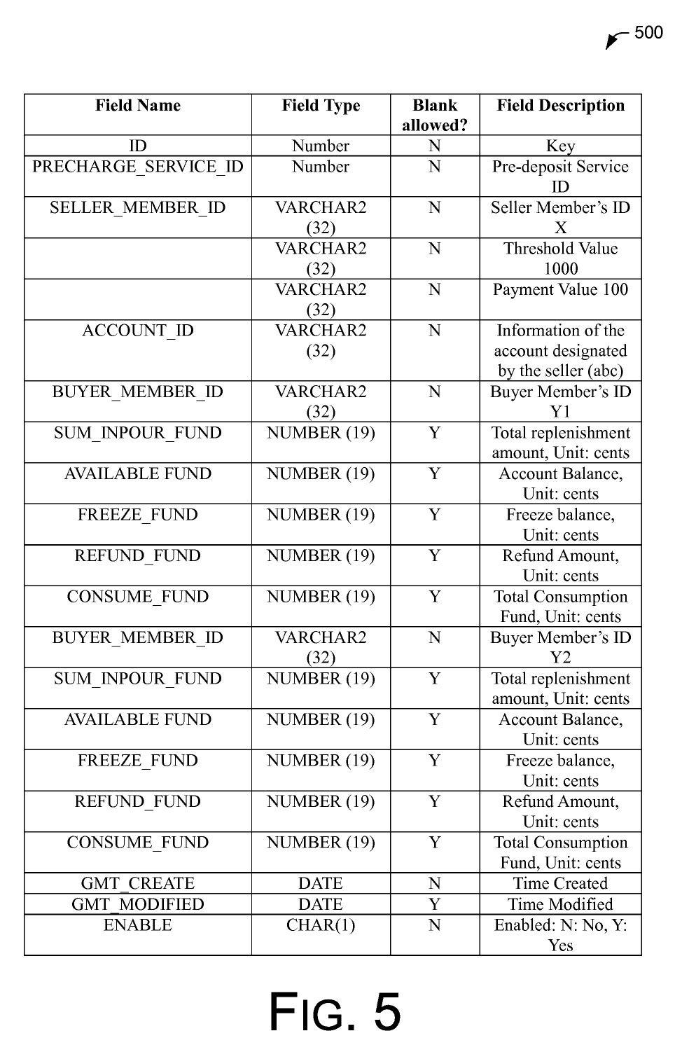

In some embodiments, the intermediate account 108 may store information associated to the seller 118 and the buyer 116 as well as information associated to payment operations. If the payment server 102 determines that many buyers have allocated funds into an intermediate account and the funds are not less than the corresponding threshold amount, the payment server 102 may separately record each buyer's ID, the buyer's fund in the intermediate account, and corresponding relationship between the buyer's ID and the buyer's account balance. FIG. 5 shows yet another illustrative account table 500. As illustrated in FIG. 5, two buyers (their IDs are Y1 and Y2) allocate funds into the intermediate account.

At 208, the payment server 102 may determine a payment request 134 that is transmitted by the buyer device 116. For example, when the buyer 112 receives goods or services provided by the seller, he or she may log in to the website implemented by the payment server 102 to make the payment request 134. After receiving the payment request 134, the payment server 102 may transmit a confirmation request to the buyer 112. The payment server 102 may execute the fund allocation operations in response to confirmation sent by the buyer 112. For example, the payment serve 102 may provide a confirmation webpage to the buyer 112, and the buyer 112 may input requested information (e.g., a payment password).

In some embodiments, when the buyer 112 receives the goods or services provided by the seller via a SMS gateway, the buyer 112 may send the payment request 134 in the form of a SMS message to the payment server 102. After the receiving the payment request 134, the payment server 102 may return a confirmation SMS message to the buyer 112. The buyer 112 may send back a SMS message containing a payment password to the payment server 102, and then the payment server 102 may execute fund allocation operations. For example, the payment server 102 may transmit the payment 132 to the seller server 106.

In some embodiments, the buyer 112 may send the payment request 134 by using a radiofrequency (RF) mode. In these instances, when receiving goods or services provided by the seller, the buyer 112 may swipe his or her RF card in the RF reading device. The RF card may include the buyer's ID and the seller's ID. The RF reading device may transmit this ID information to a background server, which may then send the payment request 134 to the payment server 102. In some embodiments, the RF card in this exemplary embodiment may be a RF component in a mobile device.

Since the payment request 134 may include the buyer's ID, the payment server 102 may search for the account balance of the buyer 112 from an intermediate account table. In some embodiments, the payment server 102 may generate intermediate accounts for multiple sellers. In these instances, the payment request 134 may include seller IDs to allow the payment server 102 to determine a corresponding intermediate account of the seller 118 based on his or her ID. In some embodiments, the buyer 112 may simultaneously perform online transactions with many sellers. In these instances, the payment request 134 may include the buyer's ID and IDs of the multiple sellers to inform the payment server 102 how to allocate funds associated with the multiple sellers.

At 210, after receiving the payment request 134, the payment server 102 may transfer the corresponding amount to the seller designated account 120. In some embodiments, the payment server 102 may determine the buyer's account balance based on the payment request 134, and may determine whether the buyer's account is not lower than the amount to be allocated. If it is not lower, the payment server 102 may allocate the corresponding amount to the seller designated account 120. If the buyer's account is lower than the amount, the payment server 102 may reject performing the online payment operations and inform the buyer 112 that the payment transaction was unsuccessful by using, for example, SMS and other methods. In some embodiments, the payment server 102 may provide reasons for the unsuccessful payment such as, for example, insufficient balance.

In some embodiments, the buyer's account balance may be in a frozen status. In these instances, the payment server 102 may determine that the current status is safe and the amount can be allocated to the seller designated account 120. The payment server 102 may then unfreeze the amount in the buyer's account balance corresponding to the payment amount 128, and allocate the unfrozen amount (e.g., the payment amount 128) to the seller designated account 120. Since the payment server 102 may only unfreeze the portion of the funds that is equal to the payment amount 128, the safety of the buyer's account balance is secured.

In some embodiments, after allocating the amount to the seller designated account 120, the payment server 102 may inform the seller 118 by using SMS and other methods that the buyer 112 has paid for the goods and/or services. In these instances, the payment server 102 may send the ID assigned to the buyer 112 upon registering in the payment server.

In some embodiments, when the buyer 112 wants to contact the seller 118 regarding online transactions, the buyer 112 may connect with the seller 118 through the online trading platform. In these instances, the buyer 112 may provide two IDs to the seller 118: one is an ID assigned to the buyer 112 upon registering in the payment server as referred to as ID 1, and another is a buyer ID that may be recognized by the seller as referred to as ID 2. The seller 118 may establish a local corresponding relationship between ID 1 and ID 2, and saves the corresponding relationship. After receiving the ID 1 from the payment server 102, the seller 118 may utilize the saved relationship to search for the corresponding ID 2. Since ID 2 is recognized by the seller 118, the buyer 112 who has paid the goods and/or services is determined

At 212, the payment server 102 may update the buyer's account balance. In some embodiments, the intermediate account 108 may be maintained by the payment server 102. In these instances, when there is a change in the account balance of the buyer 112, the payment server 102 may update the corresponding table of the intermediate account 108. The contents of the intermediate account may reflect real-time contents of the buyer's account balance.

In some embodiments, the seller 118 may define multiple threshold amount 126 for the intermediate account 108 in scales, and define the payment amount 128 for each threshold amount 126. In these instances, the buyer 112 may allocate multiple funds at one time, for example, to receive a discount offered by the seller 118.

Suppose that the seller 118 (ID as X) defines three lowest threshold amounts separately as 1000, 1500, 2000. Further suppose that the corresponding payment amount for the threshold amount of 1000 is 100, 90 for the threshold amount of 1500, and 80 for the threshold amount of 2000. As results, if allocating a one-time amount that is not less than 1000, the buyer 112 pays 100 after receiving the goods and/or services from the seller. Similarly, the buyer 112 pays 90 for allocating 1500 and pays 80 for allocating 2000.

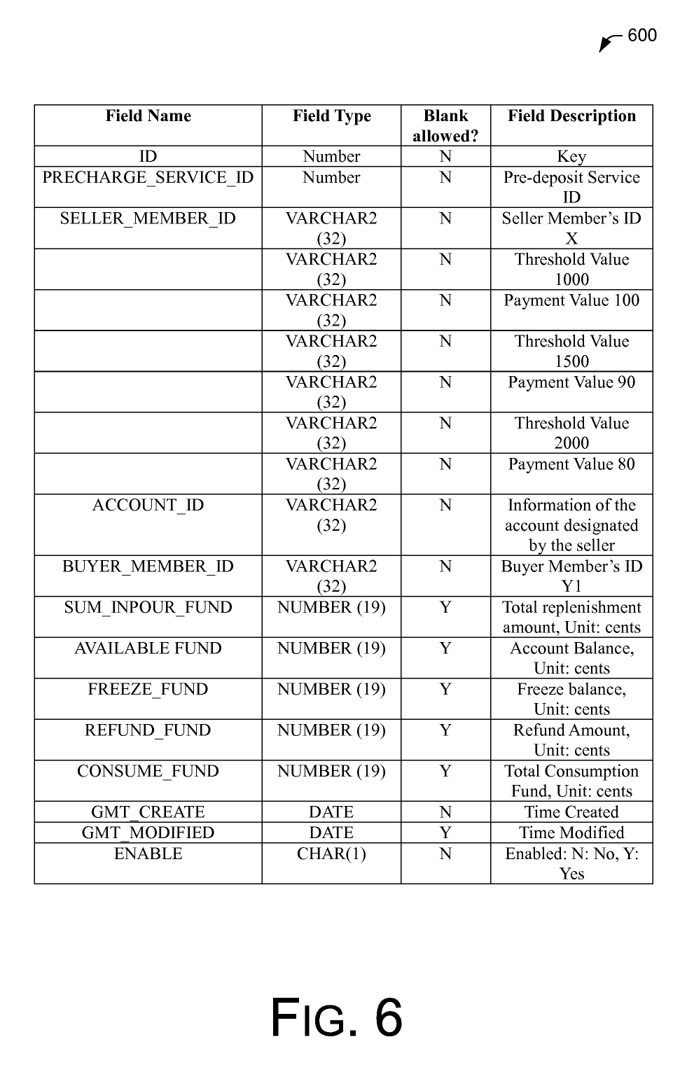

When the buyer 112 with buyer ID Y1 desires to conduct online transactions with the seller 118, the buyer 112 may allocates the amount of 1500 to the intermediate account 108. The payment server 102 may then determine whether the allocated amount falls in any of the three threshold values defined by the seller 118. As results, the payment server 102 may set the buyer's allocated amount of 1500 as the buyer's account balance, and then freeze it. The table of the intermediate account 108 is shown in an intermediate account table 600 of FIG. 6.

After receiving the payment request 134 from the buyer 112, the payment server 102 may prepare to allocate the funds 130 from the buyer designated account 114 to the intermediate account 108. After reading the contents of the intermediate account table 600, the payment server 102 may determine that the buyer 120's initial allocated amount of 1500 satisfies requirements of two threshold values (threshold value 1000 and threshold value 1500). Based on the smallest payment amount in the determined payment values, the payment server 102 may allocate the amount that corresponds (i.e., 90) to the buyer's account balance to the seller designated account 114.

In defining the threshold amount 126 and the payment amount 128 in scales, the transaction requirements of different buyers may be satisfied. In some embodiments, the buyer 112 may want to have a long-term online transaction relationship with the seller 118 to get better discounts. Even if the account balance of the buyer 112 is decreased after payment and is not able to reach the initial threshold amount, the payment server 102, based on the payment amount that was defined when the account balance was initiated (e.g., highest amount), may continue to use it in the entire payment process.

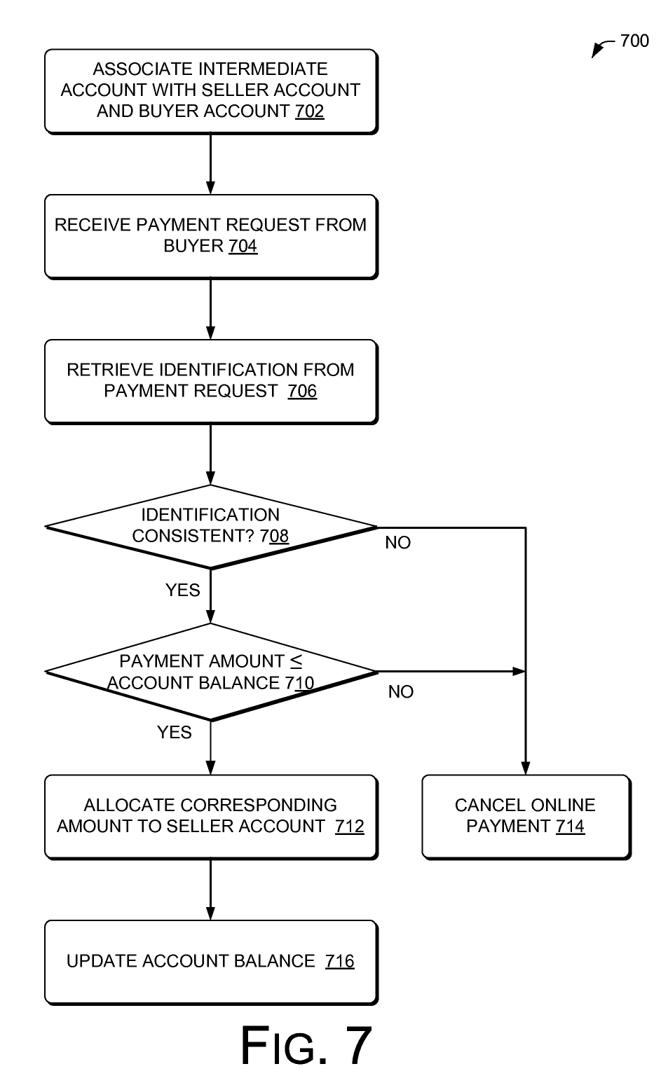

FIG. 7 is a flow diagram of an illustrative process 700 to conduct a transaction using an online payment. At 702, the payment server 702 may associate the intermediate account 108 with the buyer designated account 114 and the seller designated account 120. In some embodiments, the payment server 102 may generate the intermediate account 108 based on the threshold amount 126 and the payment account 128. In these instances, the payment server 102 may record the seller's ID as a receiver ID, and the buyer's ID as a payer ID. In some embodiments, when the buyer 112 is bound to the intermediate account's multiple sellers, the seller 118 may include sellers with chain characteristics.

At 704, the payment server 102 may receive the payment request 134 from the buyer 112. The buyer 112 and the seller 118 may initiate online transactions. If the online transactions are successful (which include the buyer 112 receiving goods and/or services provided by the seller 118), the buyer 112 may perform online payment operations. If the online transactions fail (which include the buyer 112 stopping the online transaction or the seller 116 stopping the online transaction), the buyer 112 may not perform online payment operations.

In some embodiments, the payment request 134 may include authentication parameters provided by the buyer. Based on the authentication parameters, the payment server 102 may perform identity authentication on the buyer. If the authentication fails, the payment server 102 may reject executing the online payment process. The authentication parameters may be the user ID and password assigned to the buyer 112 upon registering in the payment server 102, and may include other legitimate parameters that can be used to authenticate the identity of the buyer 112.

At 706, the payment server 102 may retrieve the payer ID and receiver ID in the payment request 134. At 708, the payment server 102 may compare the payer ID and the buyer's ID, and compare the receiver ID and the seller's ID. If they are consistent (i.e., the YES branch from 708), the payment server 102 may determine whether the payment amount 128 is not greater than the buyer's account balance. If the IDs are inconsistent (i.e., the NO branch from 708), the payment server 102 may cancel the online transaction at 714, and inform the buyer 112 and the seller 118.

At 710, a determination is made whether the payment amount is less than or equally to the account balance in the intermediate account. If the payment amount 128 is not greater than the buyer's account balance (i.e., the YES branch from 710), the payment server may allocate corresponding amount of funds to the seller designated account 120 at 712. If the payment amount 128 is greater than the buyer's account balance (i.e., the NO branch from 710), the payment server 102 may cancel the online transaction at 714 and inform the buyer 112 and the seller 118.

In some embodiments, the payment server 102 may freeze all the funds in the intermediate account 108 associated with the buyer 112. The payment server may unfreeze the amount in the intermediate account 108 that is the same as the payment amount 128, and the rest of the amounts remain frozen. In these instances, the payment server 102 may allocate the unfrozen amount to the seller designated account 114 (e.g., the seller's online bank account), implementing a one-time freezing and multiple unfreezing of accounts.

After the payment server 102 allocates funds from the intermediate account 108 to the seller designated account 114, the payment server 102 may compute a one-time online payment operation.

At 716, the payment server 102 may update the buyer's account balance based on the amount allocated to the seller designated account 114. In some embodiments, the buyer 112 may request the payment server 102 to replenish his or her account balance in a predetermined period of time and/or specific time. In these instances, the buyer may log in to the payment server 102, and enter the buyer ID, seller ID, and replenishment amount in the payment server's replenishment webpage, and allocate the replenishment amount from the buyer designated account 114 to the intermediate account 108 in the payment server. After the payment server 102 receives the buyer's allocated amount, the payment server 102 may determine the buyer's account balance from the intermediate account table 300 of FIG. 3 to the intermediate account table 600 of FIG. 6, based on the buyer ID and seller ID, and refresh the account balance.

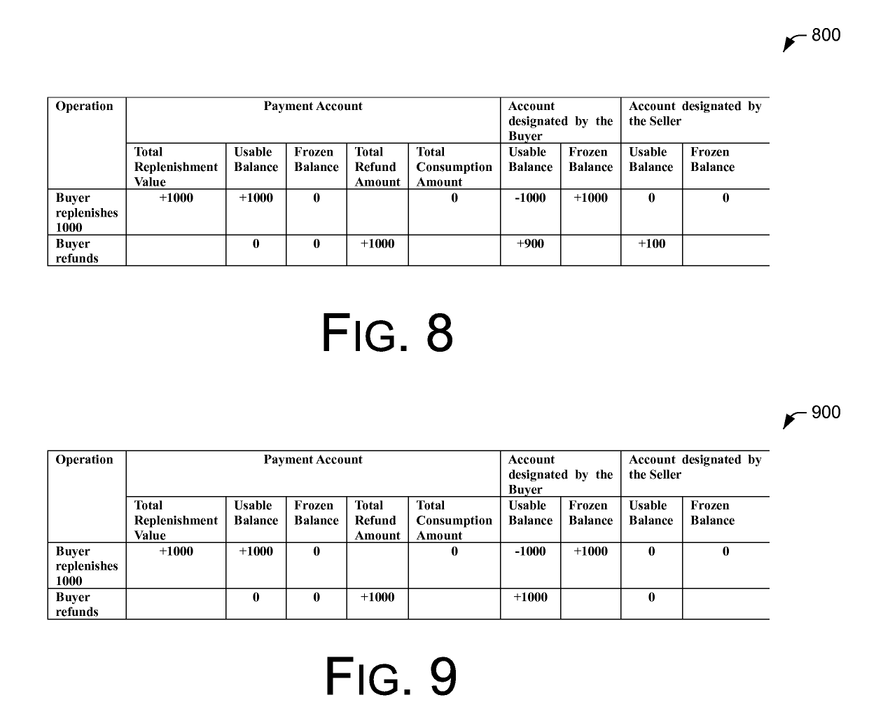

In some embodiments, the seller and buyer may end the online transaction at anytime, and request the payment server 102 to return the buyer's account balance. In these instances, the buyer may request for the return of the buyer's account balance. Since the buyer 112 may allocate a larger amount in the intermediate account 108 to obtain discounts, the seller may request to return only a portion of the amount. For example, the seller may determine the return ratio (e.g., 90%) to the buyer. The refund table is shown as an intermediate table 800 of FIG. 8. The return ratio can be recorded in the intermediate account tables 300, 400, 500 and 600 of FIGS. 3-6.

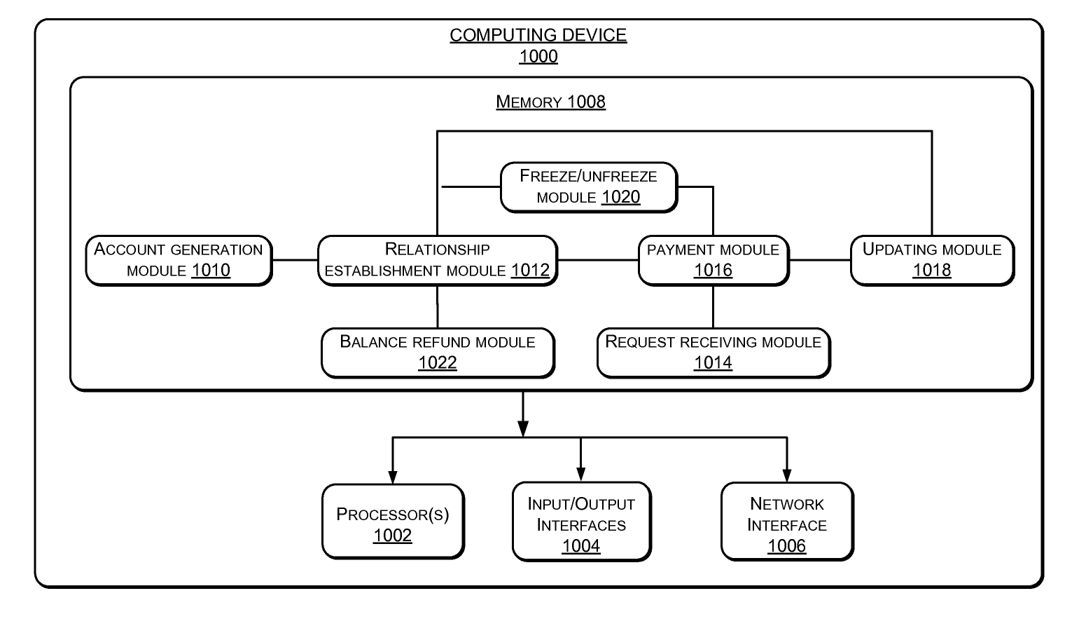

When the payment server 102 receives a request to return the balance from the seller 118 to the buyer 112, the payment server 102 may allocate all the funds in the intermediate account 108′s balance to the buyer designated account 114. The refund table is shown in an intermediate account table 900 of FIG. 9.

In some embodiments, the online transaction may include group purchase businesses. In these instances, the seller 118 may submit the buyer's lowest amount in the online payment contents that the seller 118 sends to the payment server. The payment server 102 may record the lowest amount in the condition field of the intermediate table 300 of FIG. 3. When a buyer allocates funds to the payment server 102, the payment server 102 may not immediately establish the corresponding relationship between the buyer ID and account balance; rather, the payment server 102 may trigger to record the fund allocation request and the buyer's amount when conducting online transactions with the seller 118. When the buyer's amount has reached the lowest amount, the payment server 102 may then establish the corresponding relationship of each buyer ID and the account balance. The buyer and seller may then perform online transactions.

FIG. 10 is a block diagram of an illustrative computing device 1000 of various components included in the computing environment of FIG. 1. The payment server 102 may be configured as any suitable server(s). In one exemplary configuration, the payment server 102 include one or more processors 1002, input/output interfaces 1004, network interface 1006, and memory 1008.

The memory 1008 may include computer-readable media in the form of volatile memory, such as random-access memory (RAM) and/or non-volatile memory, such as read only memory (ROM) or flash RAM. The memory 1008 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include transitory media such as modulated data signals and carrier waves.

Turning to the memory 1008 in more detail, the memory 1008 may store an account generation module 1010, a relationship establishment module 1012, a request receiver module 1014, a payment module 1016, an updating module 1018, a freeze/unfreeze module 1020, and a balance refund module 1022.

The account generation module 1010 may generate the intermediate account 108 based on the threshold amount 126 and the payment amount 128 determined by the seller 118. In some embodiments, the account generation module 1010 may open the memory space for storing the intermediate account 108, and store the intermediate account 108 in tables in the memory space. The account generation module 1010 may also input the threshold amount 126 and the payment amount 128 in the fields designated by the intermediate account 108 and the buyer designated account 114 as well as the seller designated account 120.

The relationship establishment module 1012 may designate the funds 130 in the intermediate account 108 as the buyer's account balance in the intermediate account 108 when the funds 130 in the intermediate account is not less than the threshold amount 126. In some embodiments, the relationship establishment module 1012, when the seller 118 determines that there are multiple threshold amount 126, and has determined the corresponding payment amount of each threshold amount 126. Then the payment server 102 may check if the buyer's allocated amount from the intermediate account is not less than at least one of the threshold amount. If “Yes”, the payment serve 102 may get the funds 130 as the buyer's account balance in the intermediate account 108.

The payment module 1016 may, from among multiple threshold amount 126 determined by the seller 118, search for the threshold amount 126 that is not greater than the funds 130 from the intermediate account 108. The payment module 1016 may also determine the payment amount 128 that corresponds to the threshold amount 126 that was found. And based on the smallest payment amount from among the determined payment amount 128, the funds 130 corresponding to the account balance of the buyer 112 in the intermediate account 108 may be allocated to the account designated by the seller.

In some embodiments, when the intermediate account is the intermediate account that connects the seller and the buyer, the payment module 1016 may retrieve the payer ID and receiver ID from the payment request 134. When the payer ID is the buyer's ID, the receiver ID is the seller's ID, and the payment amount 128 is not greater than the account balance of the buyer 112 in the intermediate account 108, the corresponding funds are allocated from the account balance to the seller designate account 120.

The request receiver module 1014 may receive the payment request sent by the buyer 112. The payment module 1016 may allocate the corresponding funds from the account balance of the buyer 112 to the sell designated account 120 by the seller based on the payment amount 128. The updating module 1018 may update the account balance of the buyer 112 in the intermediate account 108.

In some embodiments, the freeze/unfreeze module 1020 may freeze the buyer's account balance in the intermediate account 108. The freeze/unfreeze module 1020 may unfreeze the fund in the buyer's account balance that is the same as or equal to the payment value when there is a need to allocate funds to the seller designated account 120.

The balance refund module 1022 may allocate a portion of the funds from the buyer's account balance in the intermediate account 108 to the buyer designated account 114. And when the payment server 102 receives a balance refund requested from the seller, the balance refund module 1022 may allocate all the funds from the buyer's account balance in the intermediate account 108 to the buyer designated account 114.

The embodiments in this disclosure are merely for illustrating purposes and are not intended to limit the scope of this disclosure. A person having ordinary skill in the art would be able to make changes and alterations to embodiments provided in this disclosure. Any changes and alterations that persons with ordinary skill in the art would appreciate fall within the scope of this disclosure.

What is claimed is:

1. One or more computer-readable media storing computer-executable instructions that, when executed by one or more processors, performs acts comprising:
receiving, from a device associated with a first user, a threshold amount and a payment amount that are specified by the first user and are associated with a transaction involving sale of an item or service, the threshold amount being no less than the payment amount;
generating an intermediate account based on the threshold amount and the payment amount;
receiving, from an account designated by a second user, funds associated with the transaction of the item or service;
determining that the funds are not less than the threshold amount;
designating the funds as an account balance of the second user in the intermediate account;
receiving, from a device associated with the second user, a payment request in response to receipt of the item or service by the second user; and
transferring, based on the payment amount, all or part of the funds from the intermediate account to an account designated by the first user.

2. The one or more computer-readable media of claim 1, wherein the acts further comprise:
updating the account balance of the second user in response to the transferring the corresponding fund;
determining that the updated account balance of the second user is less than the payment amount; and
notifying the second user.

3. The one or more computer-readable media of claim 1, wherein the acts further comprise:
determining that the account balance of the second user is less than the payment amount;
receiving, from the device associated with the second user, other funds to replenish the intermediate account; and
updating the account balance of the second user.

4. The one or more computer-readable media of claim 1, wherein the acts further comprise:
determining that the funds are less than the threshold amount;
canceling the transaction; and
notifying the first user and the second user.

5. The one or more computer-readable media of claim 1, wherein the first user and the second user have no access to the intermediate account.

6. The one or more computer-readable media of claim 1, wherein the device associated with the first user is a mobile device, and the threshold amount and the payment amount are specified in a Short Messaging System (SMS) message.

7. The one or more computer-readable media of claim 1, wherein the acts further comprise:
unfreezing a portion of the account balance of the second user in response to the receiving payment request, the portion being corresponding to the payment amount; and
refreezing the account balance of the second user in response to the transferring the all or part of the funds.

8. A computer-implemented method comprising:
generating an intermediate account based on payment terms associated with a transaction involving sale of an item or service;
populating the intermediate account with the payment terms and information associated with an account designated by a first user and with an account designated by a second user;
receiving, from the account designated by the second user, funds specified for the transaction;
designating, in the intermediate account, the funds as an account balance of the second user; and
transferring, based on the payment terms, all or part of funds from the intermediate account to the account designated by the first user.

9. The computer-implemented method of claim 8, wherein the payment terms include a threshold amount and a payment amount.

10. The computer-implemented method of claim 9, further comprising:
determining that the account balance of the second user is less than the payment amount; and
notifying the first user and the second user.

11. The computer-implemented method of claim 8, wherein the payment terms include multiple threshold amounts and multiple payment amounts, each of the multiple threshold amounts being corresponding to one of the multiple payment amounts.

12. The computer-implemented method of claim 11, further comprising identifying a payment amount of the multiple payment amounts based on the funds specified for the transaction.

13. A computer-implemented method comprising:
receiving, from a device of a first user, a threshold amount and a payment amount that are associated with a transaction involving sale of an item or service;
receiving, from an account of a second user, funds that are not less than the threshold amount and are associated with the transaction;
allocating the funds as an account balance designated to the second user;
receiving, from a device of the second user, a payment request in response to receipt of the item or service; and
in response to the receiving the payment request, transferring, based on the payment amount, all or part of the funds to an account designated by the first user.

14. The computer-implemented method of claim 13, further comprising generating an intermediate account based on the threshold amount and the payment amount, the first user and the second user having no access to the intermediate account.

15. The computer-implemented method of claim 14, further comprising updating the intermediate account in response to the transferring the funds.

16. The computer-implemented method of claim 14, further comprising:
receiving, from the device associated with the second user, a request to transfer funds to replenish the intermediate account; and
updating the account balance of the second user in response to the replenishing the intermediate account.

17. The computer-implemented method of claim 13, further comprising:
assigning a first identifier to the first user in response to the receiving threshold amount and the payment amount; and
assigning a second identifier to the second user in response to the receiving the funds.

18. The computer-implemented method of claim 17, further comprising:
retrieving multiple user identifiers associated with the transaction; and
determining that the multiple user identifiers are consistent with the first identifier and the second identifier respectively.

19. The computer-implemented method of claim 13, further comprising:
unfreezing a portion of the account balance of the second user in response to the receiving payment request, the portion being corresponding to the payment amount; and
refreezing the account balance of the second user in response to the transferring the all or part of the funds.

20. The computer-implemented method of claim 13, wherein the threshold amount and the payment amount are received via a Short Messaging System (SMS) gateway.
